(19) United States
(12) Patent Application Publication
(10) Pub. No.: US 2015/0173386 A1
(43) Pub. Date: Jun. 25, 2015

(54) ACID WHEY-BASED COMPOSITIONS

(71) Applicant: DMK Deutsches Milchkontor GmbH, Zeven (DE)

(72) Inventors: Katja Borcherding, Zeven (DE); Matthias Hoch, Zeven (DE)

(21) Appl. No.: 14/581,238

(22) Filed: Dec. 23, 2014

(30) Foreign Application Priority Data
Dec. 24, 2013 (EP) 13 199 571.4

(51) Int. Cl. A23C 21/06

(52) U.S. Cl. CPC A23C 21/06

(57) ABSTRACT

Acid whey-based compositions and the end products resulting therefrom, and methods for the production of the products are proposed.

### FIELD OF THE INVENTION

The invention is in the area of milk products and relates to acid whey-based compositions and the end products resulting therefrom, and methods for the production of the products.

### PRIOR ART

Acid whey, also just called whey (also cheese whey, milk serum), is the greenish-yellow watery residual liquid that arises in the production of milk products worldwide in an amount of approx. 82 million tonnes per year. It consists to 94% of water, to 4 to 5% of lactose, and is almost fat-free. There are two kinds of whey: sweet whey (also rennet whey), which arises when milk is curdled with rennet for cheese production. Acid whey arises when milk is treated with lactic acid bacteria. After the protein has been separated as cheese or quark, the whey remains, and as a rule constitutes a waste product. Whey contains, in addition to lactic acid, also vitamins B1, B2 and B6, plus potassium, calcium, phosphorus and other minerals, but in particular up to 1% of whey protein. After separation of the high-value whey proteins by ultrafiltration, a residual product remains, which owing to its high COD content (COD: chemical oxygen demand) can only be disposed of at high cost. Apart from the inorganic salts, the main component is lactose, which owing to its low sweetening power is only of minor importance in the food industry. However, with the aid of lactic acid bacteria, lactose may be converted to lactic acid (lactate), which finds application as a preservative and acidifying agent in food production and can be used as a raw material in the chemical industry, for example in the production of polylactides, biodegradable plastics.

In contrast to acid whey, sweet whey may be used for making whey cheese. For this, sweet whey is heated, and the flocculent mass that settles after heating is the raw material for making whey cheese. Often, sweet whey is also acidified. Familiar types of cheese that are made from sweet whey are for example ricotta, ziger (a cheese made from the whey of goat's milk) or Norwegian brown cheese. In addition, whey is added to various soft drinks.

In the German language, dressing means salad dressings, which conventionally often consist of vinegar and oil. Furthermore, there are also salad dressings based on milk products and mayonnaise. These are by their nature creamier, because the basic products are already an emulsion. Salad dressings based on yoghurt have a mildly acidic basic taste, are somewhat thicker and therefore are also suitable as dips. Sweet cream is also used for a velvety taste, and acid cream or buttermilk for a sour taste and crème fraîche for a thicker emulsion.

A dressing or mayonnaise can be an oil-in-water or water-in-oil emulsion. Mayonnaise is produced industrially almost exclusively using high-speed homogenizers, so-called blenders. In particular, ring-gear dispersing machines and colloid mills are used, operating by the rotor-stator principle. The raw emulsion is pumped through the rotor-stator system of the machine, with development of pressure or intensive currents producing shearing forces, which exceed the strength of the oil droplets, so that the latter are broken up into extremely fine particles and are distributed uniformly in the emulsion. Egg yolk is mixed with seasoning (salt, pepper and a little liquid (water, lemon juice, vinegar)). While it is stirred vigorously, oil is added. At the start of emulsification, it is important that the oil is only added dropwise, to avoid “inversion” (breaking) of the emulsion. In an inverted emulsion, it is no longer the aqueous phase, but the oil phase that is the continuous phase of the emulsion. Such a mixture displays properties of a vinegar-oil salad dressing and cannot be whipped into a pasty mass typical of mayonnaise. Later, the oil can also be added in a thin stream, as the system then reacts far less sensitively and no longer has a tendency to undergo inversion. To exclude the salmonella risk, it is possible to use pasteurized or hard-boiled egg yolk. The emulsifying properties of lecithin are still fully effective even in solidified egg yolk. Or the egg yolk is replaced with milk. Then the lactoproteins serve as emulsifier.

Sauces, however, are basically based on aromatic liquids such as “sauce bases” (meat juices), wines, oils or milk products, which can be bound or thickened by various methods. Typically flour (roux), starch, egg and/or cold butter are used for this. Through the altered consistency, the other food constituents are bound together and ingredients are combined with them directly. Sauces are generally decisive in determining the character and taste of a dish through the composition of the ingredients they contain and concentration of flavours.

Thus, generally a milk base is the base of dressings, mayonnaises, sauces and/or edible emulsions. Thus, a dressing based on a fat phase that comprises conjugated linolenic acids or derivatives thereof is disclosed in EP 2055199 B1.

In EP 0689773 B1, a mayonnaise or dressing composition is disclosed, which is also based on milk. Preferably buttermilk or skimmed milk.

The aim of the present invention was to find new combinations of a composition which form a base for dressings, mayonnaises, sauces and/or edible emulsions. In particular, the aim of the present invention was to provide an economical base for dressings, mayonnaises, sauces and/or edible emulsions. At the same time, the base composition according to the invention should have a very high degree of stability and should represent a basic recipe for a wide range of applications. Another aim was to provide a possible substitute for reducing the proportion of egg yolk in the basic recipes, on the one hand in order to achieve a nutrition-physiological advantage, and on the other hand so as to be able to provide egg-free end products, at the same time without adversely affecting the stability of the composition.

### DESCRIPTION OF THE INVENTION

A first object of the invention therefore relates to an acid whey-based composition, comprising
(a) 0.01 to 99.9 wt % acid whey,
(b) 0 to 99.0 wt % milk products, selected from the group consisting of yoghurt, fermented milk, crème fraîche, sour cream, cultured cream, kefir (kefir mild),
(c) 0.001 to 5.0 wt % stabilizer,
(d) 0 to 25 wt % sugar and/or sugar substitutes and/or sweeteners,
(e) 0 to 5.0 wt % egg yolk,
wherein the sum of components (a) to (e) comes to 100 wt %.

A first preferred embodiment comprises an acid whey-based composition of this kind with
(a) 0.01 to 99.9 wt % acid whey,
(b) 0.3 to 70 wt % milk products, selected from the group consisting of yoghurt, fermented milk, crème fraîche, sour cream, cultured cream, kefir (kefir mild),
(c) 0.005 to 3.5 wt % stabilizer,
(d) 0.1 to 15 wt % sugar and/or sugar substitutes and/or sweeteners,
(e) 0 to 3 wt % egg yolk,
wherein the sum of components (a) to (e) comes to 100 wt %.

Especially preferably, such an acid whey-based composition comprises
(a) 70 to 99.5 wt % acid whey,
(b) 0.4 to 50 wt % milk products, selected from the group consisting of yoghurt, fermented milk, crème fraîche, sour cream, cultured cream, kefir (kefir mild),
(c) 0.05 to 2 wt % stabilizer,
(d) 0.5 to 9 wt % sugar and/or sugar substitutes and/or sweeteners,
(e) 0.5 to 2 wt % egg yolk,
wherein the sum of components (a) to (e) comes to 100 wt %.

Quite especially preferably, an acid whey-based composition of this kind comprises
(a) 90 to 99.0 wt % acid whey,
(b) 0.4 to 2 wt % milk products, selected from the group consisting of yoghurt, fermented milk, crème fraîche, sour cream, cultured cream, kefir (kefir mild),
(c) 0.1 to 1.2 wt % stabilizer,
(d) 0.7 to 5 wt % sugar and/or sugar substitutes and/or sweeteners,
(e) 0.8 to 1.5 wt % egg yolk,
wherein the sum of components (a) to (e) comes to 100 wt %.

Now it was found, surprisingly, that acid whey is an efficient component in such compositions, especially in dressings, mayonnaises, sauces and/or edible emulsions and/or edible foams. Acid whey is not only of high value in nutrition-physiological terms, but it has furthermore been found that acid whey, owing to its high water content, functions as a substitute for water during production, with consequent savings in the production step. Moreover, it was found, surprisingly, that the protein constituent in acid whey contributes to the stability of the end product, so that the proportion of egg yolk can be reduced or may even be omitted completely in the case of egg-free products.

In a preferred embodiment, the milk product is selected from the group consisting of yoghurt, fermented milk, crème fraîche, sour cream, cultured cream, kefir (kefir mild), wherein especially preferably yoghurt, sour cream, crème fraîche and/or cultured cream is used in the acid whey-based composition. The milk products are preferably produced from skimmed milk, cream milk or milk with standardized fat content. Especially preferably, yoghurt milk is used, which is preferably skimmed milk, cream milk or standard milk, and preferably has a fat content from 0.1 to 4.1 wt %, preferably it is skimmed milk with approx. 0.1 wt % fat content or standard milk with 3.8 to 4.1 wt % fat content.

Preferably, in the acid whey-based composition, pectins are used, which are selected from the group consisting of apple pectins and/or citrus pectins. For example pectin Classic CM 201 from Herbsreith & Fox or pectin from the company C.E. Roeper GmbH or the company W. Behrens GmbH & Co. KG or the company Birkamidon Rohstoffhandels GmbH or the company Tate & Lyle are especially preferred.

In a preferred embodiment, the egg yolk in the acid whey-based composition is derived from whole egg yolk, egg yolk powder, enzyme-treated egg yolk powder or separated egg yolk fractions, for example plasma and/or granules fractions. The egg yolk is preferably egg yolk powder, for example hen's egg yolk powder heat-stable, spray-dried, pasteurized from Sanova Foods A/S or hen's egg yolk powder Emultherm KSMS-Mix from Ovobest Eiprodukte GmbH & Co. KG. The egg yolk fractions, granules and plasma fractions are also preferred, the plasma fraction being especially preferred.

Egg yolk fractions, which are granules and plasma fractions, can be obtained both on a laboratory scale and on an industrial scale by centrifugal separation of egg yolk. In this case the focus is on the product-specific factors (pH, ionic strength, calcium content) and process variables (g number, residence time, temperature). The granules and plasma fractions obtained in centrifugal separation are spray-dried in a subsequent process step. Generally a specific functionalization of the pure fractions takes place by enzymatic modification and adjustment of the environmental conditions. The separate enzymatic modification of the pure granules and plasma fractions allows separate setting of the environmental conditions (ionic strength, pH), so that a targeted increase in the enzymatic effect is possible. The granules and plasma fractions that are obtained separately, and separately PLA2 modified and adjusted for environment, are then generally dried separately. For this, the thermal conditions (air inlet and air outlet temperature, residence time) in the dryer may be set differently for the two fractions and as a result the functionality of the fractions as structure-forming components varies widely. Egg yolk fractionation is described in the FEI (Forschungskreis der Ernahrungsindustrie e.V. (FEI), Bonn) AiF 15512N and is familiar to a person skilled in the art, so that no further explanations are required concerning its execution, as it forms part of general technical knowledge.

Substances that are preferably used as suitable stabilizers are those which stabilize in sour milk products in particular proteins. These protein stabilizers are preferably selected from cellulose derivatives, in particular CMC (E466), propylglycol alginates (E405), soybean polyose (E426), pectins (E440).

In a preferred embodiment, such an acid whey-based preparation comprises pectin as stabilizer, preferably apple pectin and/or citrus pectin, preferably in a range from 0.005 wt % to 3 wt %, preferably 0.05 wt % to 2 wt %, very particularly preferably from 0.1 wt % to 1.2 wt %.

The invention further relates to dressings, creams, sauces and/or edible emulsions and/or edible foams comprising an acid whey-based composition, which comprises
(a) 0.01 to 99.9 wt % acid whey,
(b) 0 to 99.0 wt % milk products, selected from the group consisting of yoghurt, fermented milk, crème fraîche, sour cream, cultured cream, kefir (kefir mild),
(c) 0.001 to 5.0 wt % stabilizer,
(d) 0 to 25 wt % sugar and/or sugar substitutes and/or sweeteners,
(e) 0 to 5.0 wt % egg yolk,
wherein the sum of components (a) to (e) comes to 100 wt %.

The dressings, creams, sauces and/or edible emulsions and/or edible foams may comprise additional ingredients, for example sweeteners, food-grade acid, thickeners, reducing agents, aromatic substances, vitamins, prebiotic substances, probiotic substances, flavour enhancers, active substances for masking unpleasant taste impressions, antioxidants, food colorants and mixtures thereof.

Preferably, further nutrition-physiological additives may be added to the acid whey-based composition during production, for example buttermilk, whey protein concentrate (WPC), whey protein isolate and/or whey protein hydrolysate.

The aforementioned ingredients and additives are only listed here as examples and do not represent an exhaustive list. All substances permitted for the foodstuff area may be added during processing, provided they are useful for the corresponding product. The additional ingredients will be described and listed in more detail later in the description.

The invention further relates to the use of the acid whey-based composition according to the invention as a base for dressings, creams, sauces and/or edible emulsions and/or edible foams.

In the present invention, dressings are to be understood as salad dressings based on milk products, preferably based on yoghurt. Sweet cream is also used for a velvety and delicate taste, and sour cream or buttermilk for a sour taste and crème fraîche for a thicker emulsion. A dressing can be an oil-in-water emulsion or a water-in-oil emulsion.

In the present invention, sauces are to be understood as sauces that preferably form an O/W or W/O emulsion, and are generally based on milk products that are bound or thickened with flour, starch, egg or butter. Preferably these sauces are selected from: sauce béchamel, sauce hollandaise, sauce mayonnaise, sauce bernaise, rouille and Green Sauce. Preferably a sauce mayonnaise is selected from: mayonnaise, aioli, cocktail sauce, Gloucester sauce, sauce remoulade, sauce tartare and Green Sauce.

In the present invention, creams are to be understood for example as salad cream, which is a derivative of mayonnaise, and preferably contains less fat than mayonnaise.

In the present invention, edible emulsions are to be understood as O/W and W/O emulsions, which can be produced from the acid whey-based composition according to the invention, and which may also be in the form of a cream or sauce.

Preferably the stated dressings, creams, sauces and/or edible emulsions and/or edible foams that are produced on the basis of the acid whey compositions according to the invention may also be used as cold sauce, dips or spreads or for meat or fish.

The word “base” for dressings, creams, sauces and/or edible emulsions and/or edible foams is understood in the present invention to mean that the acid whey composition is a basic composition for foods, from which the marketable end product is produced at little cost. This means that for example by adding just a few further additives (ingredients) to the acid whey-based composition, an end product is already obtained with the taste or organoleptic properties desired by the user or customer. A basic recipe of this kind simplifies the production process for dressings, creams, sauces and/or edible emulsions and/or edible foams and offers potential savings in the area of production and quick processing.

Use of the acid whey-based composition according to the invention as a base for salad dressings/creams, delicatessen dressings/creams, mayonnaise, tzatsiki and/or dip sauces is especially preferred. Especially preferably, the acid whey-based composition is used for salad dressings/creams, delicatessen dressings/creams and/or mayonnaise.

The present invention further consists in that by using the acid whey-based composition according to the invention, the acid whey used already replaces the water component in dressings, creams, sauces and/or edible emulsions and/or edible foams, so that no additional water has to be added in the production of the end product.

Replacement of the water component by the acid whey is based on the water that is already contained in the acid whey, so that as a result addition of water and therefore a step in the production process may be omitted. The water component required for the production of dressings, creams, sauces and/or edible emulsions and/or edible foams is already replaced preferably 1:1 by the water contained in the acid whey.

The use of acid whey as the main component and base for dressings, creams, sauces and/or edible emulsions and/or edible foams, in particular in the acid whey-based composition according to the invention, preferably has a high nutrition-physiological benefit or value.

The nutrition-physiological benefit and value of acid whey-based compositions according to the invention result for example from the low fat and calorie content of acid whey. Moreover, whey has a beneficial effect on the digestive tract. Some of the lactose in whey reaches the colon and can be decomposed by lactic acid bacteria to lactic acid. This promotes growth of these health-promoting intestinal bacteria and a balanced environment in the intestinal tract. Whey proteins are easily digestible. They contain abundant essential amino acids in balanced proportions, so that the biological value is very good. Immunoglobulins, lactoferrin and other substances in whey protein are bioactive, for example they support the body's defences or promote the absorption of nutrients.

The present invention further relates to the use of the acid whey-based composition according to the invention as an emulsifier system in dressings, cream, sauce and/or edible emulsions and/or edible foams.

Emulsifier system means, in the present invention, a group of various substances which act together, preferably synergistically, as emulsifier. Preferably such an emulsifier system has at least two, three, four or five components (substances). Preferably an emulsifier system according to the invention has at least acid whey or a combination of acid whey and WPC (=whey protein concentrate) or a combination of acid whey and WPC (=whey protein concentrate) and egg yolk. Egg yolk is preferably selected from whole egg yolk, egg yolk powder or egg yolk fractions (plasma and granules fraction), egg yolk powder or plasma fractions being especially preferred.

Consequently, the present invention further relates to an emulsifier system for dressings, creams, sauces and/or edible emulsions and/or edible foams, comprising the acid whey-based composition according to the invention.

In addition, the invention likewise relates to a method for producing a dressing, a cream, a sauce and/or an edible emulsion and/or edible foams, characterized in that an acid whey-based composition according to the invention is provided as a basis for the overall composition.

In the production of dressings, creams, sauces and/or edible emulsions and/or edible foams, in a first step yoghurt is produced, which is preferably skimmed milk yoghurt or standard milk yoghurt. In a next step, the yoghurt is mixed with acid whey and the acid whey base according to the invention is thus obtained. Lastly, the acid whey-based composition is processed to the end product (dressings, creams, sauces and/or edible emulsions and/or edible foams).

The milk used in the production of the acid whey-based preparation or end product may be obtained from cows, but also from other milk-producing animals, for example sheep, goats, horses and camels.

Production of Skimmed Milk

For preparing the skimmed milk for the acid whey-based composition, first there is separation of solid non-milk constituents and skimming of the fat component of about 4 wt % from the raw milk. This usually takes place in a special component, preferably a separator. Such components are adequately known from the prior art. Separators from the company GEA Westfalia Separator GmbH, with which the two steps may be carried out individually or jointly, are widely used in the milk industry.¹ Corresponding components are for example also described in DE 10036085 C1 (Westfalia) and are familiar to a person skilled in the art, so that no explanations are required concerning the execution of these process steps, as they form part of general technical knowledge. ¹ (http://www.westfalia-separator.com/de/anwendungen/molkereitechnik/milch-molke.html).

The heat treatment of the milk preferably takes place in heat exchangers, and in particular, plate-type heat exchangers have proved especially suitable. The heat exchangers have a temperature gradient, and this is selected so that the milk is heated to a temperature of about 70 to 80° C. and especially about 72 to 74° C. for a residence time of at least 20 and at most 60 seconds, preferably about 30 seconds.

Production of Milk Products

Yoghurt

As a simplification, yoghurt consists of milk, lactic acid and bacteria. The milk may be obtained from cows, but also from other milk-producing animals, for example sheep, goats, horses and camels.

Standard milk or skimmed milk (as described above) will preferably be used for further preparation of the yoghurt. Bacterial cultures are added to the milk. The bacterial cultures decompose the lactose (milk sugar) to lactic acid, so that the milk protein coagulates. This so-called fermentation leads not only to the more or less solid consistency and the typical yoghurt odour and taste, but also to a far longer shelf life. In modern production, in contrast to before, heat-treated milk with adjusted fat content is always used. Moreover, as the manufacturers do not leave the type and composition of the lactic acid cultures used simply to chance, they already exert an influence on the structure and flavour. Preferably, thermophilic bacterial cultures are used, which prefer a temperature of approx. 38 to 42 degrees and which are mainly selected from the species Streptococcus thermophilus and Lactobacillus (delbrueckii subsp. bulgaricus), Bifidobacterium bifidum for mild yoghurt types with a lower lactic acid content. Also, with a view to good consistency, very often skimmed milk powder is also added or the water content of the starting milk is reduced by evaporation. The heating of the milk that is generally necessary also serves not only for protection against harmful microorganisms, but also develops the yoghurt gels.

A distinction may be made between compact or stirred yoghurt. For stirred or thick yoghurt, after addition of the yoghurt cultures, the milk is fermented for several hours in large steel tanks. Thermophilic bacteria work best in the temperature range from 38 to 42° C. The lactic acid that forms causes caseins (particular fractions of lactoprotein) to coagulate slowly to a gelatinous network, in which the liquid whey is enclosed. As soon as a particular pH (acid value) is reached, the yoghurt is stirred until smooth, cooled to refrigerator temperature, filled and sealed immediately. As the viscosity increases after packing, the marketable product may have a similar appearance to compact yoghurt. However, this second variant is produced with filling of the milk-culture mixture in yoghurt pots at once, i.e. the fermentation process takes place before cooling. While the mixture coagulates in the pot, there must not be any movement that disturbs gelling. Also in the case of compact yoghurt, rapid cooling stops the fermentation after the desired pH is reached. Finally, the pots go into a cold chamber, where the yoghurt then finally becomes solid.

Fermented Milk

Fermented milk, sour milk, soured milk or set milk is a milk product obtained from cow's milk. Today it is formed mainly from pasteurized—previously from unboiled—and homogenized cow's milk through bacterial lactic acid formation from lactose. This results in coagulation of the casein, which then makes the milk “thick”. In contrast to yoghurt (thermophilic cultures, optimum temperature 42-45° C.), in the production of fermented milk, mesophilic (optimum temperature 22-28° C.) cultures are added.

Crème Fraîche

Crème fraîche is produced from cream, to which lactic acid bacteria are added. The lactic acid bacteria convert the lactose to lactic acid, preferably at a temperature from 20 to 40° C. This gives crème fraîche its special taste and consistency. Crème fraîche preferably has a fat content of approx. 30%.

Sour Cream

Sour cream (crème aigre, also crème acidulée) is cream to which lactic acid bacteria have been added, so that in addition to a slightly sour taste it takes on a solid, creamy consistency. Sour cream is sold in several variants with these names:
Sour cream, which contains at least 10% fat.
Crème légère is a lower-fat variant of crème fraîche with a fat content generally of about 20%.
Cultured cream is a higher-fat sour cream with a fat content generally of 20-29%. Addition of binders (generally starch) is permitted.
Crème fraîche (crème fraîche épaisse) contains at least 30% fat; addition of up to 15% sucrose is permitted. Crème fraîche should not undergo any further heat treatment after fermentation.

Cultured Cream

Cultured cream is produced by fermentation of cream after adding various mesophilic lactic acid bacteria (Lactococcus lactis, Lactococcus lactis subsp. cremoris, Ln. cremoris and Lc. diacetilactis) cultures. The bacteria produce lactic acid, which in its turn makes the cream sour and at the same time thicker. Cultured cream preferably contains 20-29% fat.

Kefir (Kefir Mild)

Industrially produced, commercially available kefir usually does not correspond to the traditional drink produced with kefir lumps and is designated “kefir, mild”. So that the resultant drink always has the same taste, a defined mixture of different bacteria and yeasts is used industrially, which cannot completely imitate the complex composition of the consortium of microorganisms of kefir grains.

Production of the Acid Whey Base

The milk product produced (yoghurt, sour cream, crème fraîche, cultured cream, kefir, fermented milk) is mixed with acid whey. The milk product is preferably yoghurt and is preferably derived from skimmed milk or standardized milk. The other ingredients, such as preferably pectin, WPC, buttermilk powder, sugar and egg yolk (powder/fraction) can now be added to this mixture. Then it is heated, the temperature preferably being 80 to 150° C., especially preferably 85 to 100° C., and quite especially 90 to 95° C. (±3° C.). Next the mass is homogenized under pressure, preferably maintaining the temperature, and the pressure is from 100 to 350 bar, preferably from 200 to 300 bar and especially preferably from 250 to 280 bar. Then it is cooled to 4° C.

The resultant acid whey base is a semi-finished product, which can be formulated to the end product in a few steps. For example, additional flavourings may be added to the acid whey base, to achieve a particular taste, or prebiotic additives, for further increasing the content of nutrition-physiological substances.

Next, the additional ingredients, which may be added both during production of the acid whey base, and for completing the end product (dressing, cream, sauce and/or edible emulsion and/or edible foams), may be added to the semi-finished product.

Food Additives

The foodstuffs may have further ingredients, e.g. sweeteners, foodstuff acids, acid regulators, thickeners and especially flavourings.

Sweeteners

As sweeteners or sweet-tasting additives, firstly carbohydrates and especially sugars may come into consideration, such as sucrose, trehalose, lactose, maltose, melezitose, raffinose, Palatinose, lactulose, D-fructose, D-glucose, D-galactose, L-rhamnose, D-sorbose, D-mannose, D-tagatose, D-arabinose, L-arabinose, D-ribose, D-glycerol aldehyde, or maltodextrin. Vegetable preparations that contain these substances are also suitable, for example based on sugar beet (Beta vulgaris ssp., sugar fractions, sugar syrup, molasses), sugar cane (Saccharum officinarum ssp., molasses, sugar cane syrup), maple syrup (Acer ssp.) or agave (agave nectar).

Consideration may also be given to synthetic, i.e. as a rule enzymatically produced starch or sugar hydrolysates (invert sugar, fructose syrup);
fruit concentrates (e.g. based on apples or pears);
sugar alcohols (e.g. erythritol, threitol, arabitol, ribitol, xylitol, sorbitol, mannitol, dulcitol, lactitol);
proteins (e.g. miraculin, monellin, thaumatin, curculin, brazzein);
sweeteners (e.g. Magap, sodium cyclamate, acesulfame K, neohesperidin dihydrochalcone, saccharin sodium salt, aspartame, superaspartame, neotame, alitame, sucralose, steviosides, rebaudiosides, lugduname, carrelame, sucrononate, sucrooctate, monatin, phenylodulcin);
sweet-tasting amino acids (e.g. glycine, D-leucine, D-threonine, D-asparagine, D-phenylalanine, D-tryptophan, L-proline);
other sweet-tasting low-molecular substances, e.g. hernandulcin, dihydrochalcone glycosides, glycyrrhizin, glycyrrhetic acid, derivatives and salts thereof, extracts of liquorice (Glycyrrhizza glabra ssp.), Lippia dulcis extracts, Momordica ssp. extracts or
individual substances, e.g. Momordica grosvenori [Luo Han Guo] and the mogrosides obtained therefrom, Hydrangea dulcis or Stevia ssp. (e.g. Stevia rebaudiana) extracts.

Acidification Agents

The foodstuffs may contain foodstuff acids. Acids in the sense of the invention are preferably acids permitted in foodstuffs, especially those stated here:

| | |
|---|---|
| E 260 | acetic acid |
| E 270 | lactic acid |
| E 290 | carbon dioxide |
| E 296 | malic acid |
| E 297 | fumaric acid |
| E 330 | citric acid |
| E 331 | sodium citrate |
| E 332 | potassium citrate |
| E 333 | calcium citrate |
| E 334 | tartaric acid |
| E 335 | sodium tartrate |
| E 336 | potassium tartrate |
| E 337 | sodium-potassium tartrate |
| E 338 | phosphoric acid |
| E 353 | metatartaric acid |
| E 354 | calcium tartrate |
| E 355 | adipic acid |
| E 363 | succinic acid |
| E 380 | triammonium citrate |
| E 513 | sulphuric acid |
| E 574 | gluconic acid |
| E 575 | glucono-delta-lactone |

Acid Regulators

Acid regulators are food additives that keep the acidity or basicity and thus the desired pH of a foodstuff constant. They are generally organic acids and salts thereof, carbonates, less often also inorganic acids and salts thereof. Addition of an acid regulator partly intensifies the stability and strength of the foodstuff, brings about desirable precipitation and improves the action of preservatives. In contrast to acidifiers, they are not used for altering the taste of foodstuffs. Their action is based on the formation of a buffer system in the foodstuff, so that addition of acidic or basic substances has little or no effect on the pH. Examples are:

| | |
|---|---|
| E 170 | calcium carbonate |
| E 260-263 | acetic acid and acetates |
| E 270 | lactic acid |
| E 296 | malic acid |
| E 297 | fumaric acid |
| E 325-327 | lactates (lactic acid) |
| E 330-333 | citric acid and citrates |
| E 334-337 | tartaric acid and tartrates |
| E 339-341 | orthophosphates |
| E 350-352 | malates (malic acid) |
| E 450-452 | di-, tri- and polyphosphates |
| E 500-504 | carbonates (carbonic acid) |
| E 507 | hydrochloric acid and chlorides |
| E 513-517 | sulphuric acid and sulphates |
| E 524-528 | hydroxides |
| E 529-530 | oxides |
| E 355-357 | adipic acid and adipates |
| E 574-578 | gluconic acid and gluconates |

Thickeners

Thickeners are substances which first and foremost are able to bind water. Withdrawal of unbound water leads to an increase in viscosity. Starting from a characteristic concentration for each thickener, in addition to this effect there are also network effects, which generally lead to a disproportionate increase in viscosity. It is said in this case that molecules ‘communicate’ with one another, i.e. “form loops”. Most thickeners are linear or branched macromolecules (e.g. polysaccharides or proteins), which can interact with one another through intermolecular interactions, such as hydrogen bridges, hydrophobic interactions or ionic bonds. Extreme cases of thickeners are sheet silicates (bentonites, hectorites) or hydrated SiO₂ particles, which are present dispersed as particles and can bind water in their solid-like structure or can interact with one another owing to the interactions described. Examples are:

| | |
|---|---|
| E 400 | alginic acid |
| E 401 | sodium alginate |
| E 402 | potassium alginate |
| E 403 | ammonium alginate |
| E 404 | calcium alginate |
| E 405 | propylene glycol alginate |
| E 406 | agar-agar |
| E 407 | carrageen, furcelleran |
| E 407 | carob kernel flour |
| E 412 | guar kernel flour |
| E 413 | tragacanth |
| E 414 | gum arabic |
| E 415 | xanthan |
| E 416 | karaya (Indian tragacanth) |
| E 417 | tara kernel flour (Peruvian carob kernel flour) |
| E 418 | gellan |
| E 440 | pectin, opecta |
| E 440ii | amidated pectin |
| E 460 | microcrystalline cellulose, cellulose powder |
| E 461 | methylcellulose |
| E 462 | ethylcellulose |
| E 463 | hydroxypropylcellulose |
| E 465 | methylethylcellulose |
| E 466 | carboxymethylcellulose, sodium carboxymethylcellulose |

Aromatic Substances

The invention also in particular allows the use of aromatic substances (flavourings) with ester, aldehyde or lactone structure, which are degraded particularly quickly in the presence of titanium dioxide and under the action of light. The invention therefore also provides improved stability, especially storage stability of the aromatic substances.

The oral preparations according to the invention may contain one or more aromatic substances. Typical examples comprise: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovalerate, isobutyl butyrate, isobutyraldehyde, isoeugenol methyl ether, isopropylmethyl thiazole, lauric acid, levulinic acid, linalool, linalool oxide, linalyl acetate, menthol, menthofuran, methyl anthranilate, methyl butanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulphurol, terpinene, terpineol, terpinols, 8,3-thiomenthanone, 4,4,2-thiomethylpentanone, thymol, delta-undecalactone, gamma-undecalactone, valencene, valeric acid, vanillin, acetoin, ethyl vanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyl deltadecalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate, 4-(p-hydroxyphenyl)-2-butanone, 1,1-dimethoxy-2,2,5-trinnethyl-4-hexane, 2,6-dimethyl-5-hepten-1-al and phenyl acetaldehyde, 2-methyl-3-(methylthio)furan, 2-methyl-3-furanthiol, bis(2-methyl-3-furyl)disulphide, furfuryl mercaptan, methional, 2-acetyl-2-thiazoline, 3-mercapto-2-pentanone, 2,5-dimethyl-3-furanthiol, 2,4,5-trimethyl thiazole, 2-acetyl thiazole, 2,4-dimethyl-5-ethyl thiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetyl pyrazine, 2-pentyl pyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamon alcohol, methyl salicylate, isopulegol and (not explicitly stated here) stereoisomers, enantiomers, positional isomers, diastereomers, cis/trans isomers or epimers of these substances.

Vitamins

In another embodiment of the present invention, the food additives may contain vitamins, as another optional group of additives. Vitamins have the most varied mechanisms of biochemical action. Some act similarly to hormones and regulate the metabolism of minerals (e.g. vitamin D), or act on the growth of cells and tissues and on cellular differentiation (e.g. some forms of vitamin A). Others are antioxidants (e.g. vitamin E and under certain circumstances also vitamin C). The largest number of vitamins (e.g. the B vitamins) are precursors for enzyme co-factors, which support enzymes in the catalysis of certain metabolic processes. In this connection, vitamins may sometimes be tightly bound to the enzymes, for example as part of the prosthetic group: an example of this is biotin, which is part of the enzyme that is responsible for the formation of fatty acids. Vitamins may on the other hand also be bound less strongly and then act as co-catalysts, for example as groups that can easily be split off, and transport chemical groups or electrons between the molecules. Thus, for example folic acid transports methyl, formyl and methylene groups into the cell. Although their support in enzyme-substrate reactions is well known, their other properties are also of great importance for the body.

In the context of the present invention, substances may come into consideration as vitamins that are selected from the group consisting of
vitamin A (retinol, retinal, beta-carotene),
vitamin B₁ (thiamine),
vitamin B₂ (riboflavin),
vitamin B₃ (niacin, nicotinamide),
vitamin B₅ (pantothenic acid),
vitamin B₆ (pyridoxine, pyridoxamine, pyridoxal),
vitamin B₇ (biotin),
vitamin B₉ (folic acid, folinic acid),
vitamin B₁₂ (cyanocobalamin, hydroxocobalamin, methylcobalamin),
vitamin C (ascorbic acid),
vitamin D (cholecalciferol),
vitamin E (tocopherols, tocotrienols) and
vitamin K (phylloquinone, menaquinone).
   The preferred vitamins are, in addition to ascorbic acid, the tocopherols group.

Prebiotic Substances

In another embodiment of the invention, the preparations may furthermore contain prebiotic substances (“prebiotics”), which form group H. Prebiotics are defined as indigestible food constituents, ingestion of which stimulates the growth or the activity of a number of useful bacteria in the colon. Addition of prebiotic compounds improves the stability of anthocyanins against degradation processes in the intestinal tract. Various substances, especially carbohydrates, that are especially preferred as prebiotics in the sense of the invention, are presented below.

Fructooligosaccharides. Fructooligosaccharides (FOS) in particular comprise short-chain representatives with 3 to 5 carbon atoms, for example D-fructose and D-glucose. FOS, also called neosugars, are produced commercially on the basis of sucrose and the enzyme fructosyl transferase obtained from fungi. FOS support in particular the growth of bifidobacteria in the gut and are marketed, mainly in the USA, together with probiotic bacteria in various functional foodstuffs.

Inulins. Inulins belong to a group of naturally occurring fructose-containing oligosaccharides. They belong to a class of carbohydrates called fructans. They are obtained from the roots of the chicory plant (Cichorium intybus) or so-called Jerusalem artichokes. Inulins consist mainly of fructose units and typically have a glucose unit as end group. The fructose units are linked together via a beta-(2-1)glycosidic bond. The average degree of polymerization of inulins that find application as prebiotics in the food industry is in the range 10 to 12. Inulins also stimulate the growth of bifidobacteria in the colon.

Isomaltooligosaccharides. This group is a mixture of alpha-D-linked glucose oligomers, including isomaltose, panose, isomaltotetraose, isomaltopentaose, nigerose, kojibiose, isopanose and higher branched oligosaccharides. Isomaltooligosaccharides are produced by various enzymatic routes. They also stimulate the growth of bifidobacteria and lactobacilli in the colon. Isomaltooligosaccharides are used especially in Japan as food additives in functional foodstuffs. They are now also being used more widely in the USA.

Lactilol. Lactilol is the disaccharide of lactulose. It is used medically against constipation and in hepatic encephalopathy. Lactilol is used as a prebiotic in Japan. It resists degradation in the upper digestive tract, but is fermented by various intestinal bacteria, which leads to an increase in biomass of bifidobacteria and lactobacilli in the gut. Lactilol is also known by the chemical name 4-O-(beta-D-galactopyranosyl)-D-glucitol. The medical applications of lactilol in the USA are limited owing to lack of research; in Europe it is preferably used as a sweetener.

Lactosucrose. Lactosucrose is a trisaccharide that is made up of D-galactose, D-glucose and D-fructose. Lactosucrose is produced by enzymatic transfer of the galactosyl residue in lactose to sucrose. It is not broken down in the stomach or in the upper part of the intestinal tract and is consumed exclusively by bifidobacteria for growth. From the physiological standpoint, lactosucrose acts as a stimulator of the growth of the intestinal flora. Lactosucrose is also known as 4G-beta-D-galactosucrose. It is widely used in Japan as a food additive and as a constituent of functional foods, in particular also as an additive for yoghurts. Lactosucrose is also currently being tested in the USA for similar applications.

Lactulose. Lactulose is a semi-synthetic disaccharide from D-lactose and D-fructose. The sugars are linked via a beta-glycosidic bond, which makes them resistant to hydrolysis by digestive enzymes. Instead, lactulose is fermented by a limited number of gut bacteria, which leads to growth especially of lactobacilli and bifidobacteria. In the USA, lactulose is a prescription medicine against constipation and hepatic encephalopathy. In Japan, however, it is sold freely as a food additive and constituent of functional foods.

Pyrodextrins. Pyrodextrins comprise a mixture of glucose-containing oligosaccharides, which are formed in the hydrolysis of starch. Pyrodextrins promote the proliferation of bifidobacteria in the colon. They too are not broken down in the upper part of the intestine.

Soya oligosaccharides. This is a group of oligosaccharides that occur essentially only in soya beans and additionally in other beans and peas. The two main representatives are the trisaccharide raffinose and the tetrasaccharide stachyose. Raffinose is composed of one molecule each of D-galactose, D-glucose and D-fructose. Stachyose consists of two molecules of D-galactose and one molecule each of D-glucose and D-fructose. Soya oligosaccharides stimulate the growth of bifidobacteria in the colon and are already used in Japan as food additives and in functional foods. They are currently being tested in the USA for this application.

Transgalactooligosaccharides. Transgalactooligosaccharides (TOS) are mixtures of oligosaccharides based on D-glucose and D-galactose. TOS are produced starting from D-lactose with the aid of the enzyme betaglucosidase from Aspergillus oryzae. Like many other prebiotics, TOS are also stable in the small intestine and stimulate the growth of bifidobacteria in the colon. TOS are already marketed as food additives both in Europe and in Japan.

Xylooligosaccharides. Xylooligosaccharides contain beta-1,4-linked xylose units. The degree of polymerization of the xylooligosaccharides is between 2 and 4. They are obtained by enzymatic hydrolysis of the polysaccharide xylan. They are already marketed as food additives in Japan; in the USA they are still at the phase of testing.

Biopolymers. Suitable biopolymers that also come into consideration as prebiotics, for example beta-glucans, are characterized in that they are produced on a plant basis, for example possible raw materials are cereals such as oats and barley, but also fungi, yeasts and bacteria. Microbially produced cell wall suspensions or whole cells with high beta-glucan content are also suitable. Residual fractions of monomers have 1-3 and 1-4 or 1-3 and 1-6 linkages, and the content may vary widely. Preferably beta-glucans are obtained on the basis of yeasts, especially Saccharomyces, in particular Saccharomyces cerevisiae. Other suitable biopolymers are chitin and chitin derivatives, especially oligoglucosamine and chitosan, which is a typical hydrocolloid.

Galactooligosaccharides (GOS). Galactooligosaccharides are produced by the enzymatic transformation of lactose, a component of bovine milk. GOS generally comprise a chain of galactose units, which are formed by successive transgalactosylation reactions, and have a terminal glucose unit. Terminal glucose units are mostly formed by early hydrolysis of GOS. The degree of polymerization of the GOS may fluctuate quite widely and ranges from 2 to 8 monomer units. Several factors determine the structure and the order of the monomer units: the enzyme source, the starting material (lactose concentration and origin of the lactose), the enzymes participating in the process, conditions during processing and the composition of the medium.

Probiotic Microorganisms

Probiotic microorganisms, also called “probiotics”, which form group (N), are live microorganisms, which possess properties that are useful for the host. According to the FAO/WHO definition, they are “live microorganisms which at appropriate dosage give the host a health advantage”. Lactic acid bacteria (LAB) and bifidobacteria are the best known probiotics; however, various yeasts and bacilli may be used. Probiotics are usually ingested as a constituent of fermented foods, to which special live cultures have been added, e.g. yoghurt, soya yoghurt or other probiotic foods. Furthermore, tablets, capsules, powder and sachets are also available, which contain the microorganisms in freeze-dried form. Table 1 gives a review of commercially available probiotics and the associated health benefits, which may be used in the sense of the present invention as component (b1).

TABLE 1
Probiotic substances

| Strain | Name | Manufacturer | Benefit |
|---|---|---|---|
| Bacillus coagulans GBl- | GanedenBC | Ganeden | Increases the immune response |
| 30, 6086 | | Biotech | in viral infection |
| Bifidobacterium | Probio-Tec | Chr. Hansen | Clinical studies on humans have |
| animalis subsp. lactis | Bifidobacterium | | shown that BB-12 alone or in |
| BB-12 | BB-12 | | combination has a positive |
| | | | influence on the |
| | | | gastrointestinal system. |
| Bifidobacterium infantis | Align | Procter & | It was shown in a preliminary |
| 35624 | | Gamble | study that the bacterium may |
| | | | reduce abdominal pains. |
| Lactobacillus acidophilus | | Danisco | A study has shown that the |
| NCFM | | | side-effects of antibiotic |
| | | | treatments are reduced. |
| Lactobacillus paracasei | | | |
| St11 (or NCC2461) | | | |
| Lactobacillus johnsonii | | Nestlé | Decrease in gastritis complaints |
| La1 (=Lactobacillus LC1, | | | and reduced inflammation |
| Lactobacillus johnsonii | | | |
| NCC533) | | | |
| Lactobacillus plantarum | GoodBelly/ | Probi | Might improve IBS symptoms; |
| 299v | ProViva/ | | however, further studies |
| | ProbiMage | | required. |
| Lactobacillus reuteri | | BioGaia | Initial indication for efficacy |
| American Type Culture | | | against gingivitis, fever in |
| Collection ATTC 55730 | | | children and decrease in days |
| (Lactobacillus reuteri | | | of disease in adults. |
| SD2112) | | | |
| Lactobacillus reuteri | | | |
| Protectis (DSM 17938, | | | |
| daughter strain of ATCC | | | |
| 55730) | | | |
| Lactobacillus reuteri | | | |
| Protectis (DSM 17938, | | | |
| daughter strain of ATCC | | | |
| 55730) | | | |
| Saccharomyces boulardii | DiarSafe and | Wren | Limited proof in the treatment |
| | others | Laboratories | of acute diarrhoea diseases. |
| Lactobacillus rhamnosus | Bion Flore | Chr. Hansen | In one study, proof of efficacy |
| GR-1 & Lactobacillus | Intime/Jarrow | | against vaginitis. |
| reuteri RC-14 | Fem-Dophilus | | |
| Lactobacillus acidophilus | Florajen3 | American | First indications of efficacy |
| NCFM & | | Lifeline, Inc | against CDAD |
| Bifidobacterium bifidum | | | |
| BB-12 | | | |
| Lactobacillus acidophilus | Bio-K+ | Bio-K+ | Indications of improvement of |
| CL1285 & Lactobacillus | CL1285 | International | digestion, especially with |
| casei LBC80R | | | respect to lactose intolerance. |
| Lactobacillus plantarum | Bravo | Probi | Studies in progress regarding |
| HEAL 9 & Lactobacillus | Friscus/ | | efficacy against colds. |
| paracasei 8700: 2 | ProbiFrisk | | |

Two further forms of lactic acid bacteria that may also be used as probiotics are stated below:
Lactobacillus bulgaricus;
Streptococcus thermophilus;
   Special fermented products based on these lactic acid bacteria may also be used:
mixed pickles
fermented bean paste such as tempeh, miso and doenjang;
kefir;
buttermilk
kimchi;
pao cai;
soya sauce;
zha cai.

Flavour Enhancers

These preparations—as well as flavouring mixtures—may also contain additional aromatic substances for intensifying a salty, optionally slightly sour and/or umami taste impression. Therefore the products or flavouring mixtures according to the invention are used in combination with at least one further substance suitable for intensifying a pleasant taste impression (salty, umami, optionally slightly sour). Salty tasting compounds and salt-intensifying compounds are preferred. Preferred compounds are disclosed in WO 2007/045566. Umami compounds as described in WO 2008/046895 and EP 1 989 944 are further preferred.

Flavouring mixtures and products preferred according to the invention may also further comprise aromatic substances for masking bitter and/or astringent taste impressions (flavour correctants). The (further) flavour correctants are selected for example from the following list: nucleotides (e.g. adenosine-5′-monophosphate, cytidine-5′-monophosphate) or pharmaceutically acceptable salts thereof, lactisols, sodium salts (e.g. sodium chloride, sodium lactate, sodium citrate, sodium acetate, sodium gluconate), further hydroxyflavanones (e.g. eriodictyol, homoeriodictyol or sodium salts thereof), especially according to US 2002/0188019, hydroxybenzoic acid amides according to DE 10 2004 041 496 (e.g. 2,4-dihydroxybenzoic acid vanillyl amide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxybenzyl)amide monosodium salt, 2,4-dihydroxybenzoic acid-N-2-(4-hydroxy-3-methoxyphenyl)-ethyl amide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide (aduncamide), 4-hydroxybenzoic acid vanillyl amide), bitter masking hydroxydeoxybenzoins e.g. according to WO 2006/106023 (e.g. 2-(4-hydroxy-3-methoxyphenyl)-1-(2,4,6-trihydroxyphenyl)ethanone, 1-(2,4-dihyd roxyphenyl)-2-(4-hydroxy-3-methoxyphenyl)ethanone, 1-(2-hydroxy-4-methoxyphenyl)-2-(4-hydroxy-3-methoxy-phenyl)ethanone), amino acids (e.g. gamma-aminobutyric acid according to WO 2005/096841 for reducing or masking an unpleasant taste impression such as bitterness), malic acid glycosides according to WO 2006/003107, salty-tasting mixtures according to PCT/EP 2006/067120 diacetyl trimers according to WO 2006/058893, mixtures of whey proteins with lecithins and/or bitter-masking substances such as gingerdiones according to WO 2007/003527.

Preferred flavourings are those that produce a sweet odour impression, wherein the further flavouring or flavourings that produce a sweet odour impression are preferably selected from the group consisting of:

vanillin, ethylvanillin, ethylvanillin isobutyrate (=3-ethoxy-4-isobutyryloxybenzaldehyde), furaneol (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, fruit esters and fruit lactones (e.g. acetic acid-n-butyl ester, acetic acid isoamyl ester, propionic acid ethyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, 4-hydroxycinnamic acid, 4-methoxy-3-hydroxycinnamic acid, 3-methoxy-4-hydroxycinnannic acid, 2-hydroxycinnamic acid, 2,4-dihydroxybenzoic acid, 3-hydroxybenzoic acid, 3,4-dihydroxybenzoic acid, vanillic acid, homovanillic acid, vanillomandelic acid and phenylacetaldehyde.

Active Substances for Masking Unpleasant Taste Impressions

Furthermore, the oral preparations may also comprise further substances that also serve for masking bitter and/or astringent taste impressions. These further flavour correctants are selected for example from the following list: nucleotides (e.g. adenosine-5′-monophosphate, cytidine-5′-monophosphate) or physiologically acceptable salts thereof, lactisols, sodium salts (e.g. sodium chloride, sodium lactate, sodium citrate, sodium acetate, sodium gluconate), hydroxyflavanones, here preferably eriodictyol, sterubin (eriodictyol-7-methyl ether), homoeriodictyol, and sodium, potassium, calcium, magnesium or zinc salts thereof (especially as described in EP 1258200 A2, which with respect to the corresponding compounds disclosed therein forms part of this application by reference), hydroxybenzoic acid amides, here preferably 2,4-dihydroxybenzoic acid vanillyl amide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxy-benzyl)amide monosodium salt, 2,4-dihydroxybenzoic acid-N-2-(4-hydroxy-3-methoxy-phenyl)ethyl amide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide; 4-hydroxybenzoic acid vanillyl amides (especially as described in WO 2006/024587, which with respect to the corresponding compounds disclosed therein forms part of this application by reference); hydroxydeoxybenzoins, here preferably 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)-ethanone and 1-(2-hydroxy-4-methoxyphenyl)-2-(4-hydroxy-3-methoxyphenyl)ethanone) (especially as described in WO 2006/106023, which with respect to the corresponding compounds disclosed therein forms part of this application by reference); hydroxyphenylalkanedione, for example gingerdione-[2], gingerdione-[3], gingerdione-[4], dehydrogingerdione-[2], dehydrogingerdione-[3], dehydrogingerdione-[4]) (especially as described in WO 2007/003527, which with respect to the corresponding compounds disclosed therein forms part of this application by reference); diacetyl trimers (especially as described in WO 2006/058893, which with respect to the corresponding compounds disclosed therein forms part of this application by reference); gamma-aminobutyric acids (especially as described in WO 2005/096841, which with respect to the corresponding compounds disclosed therein forms part of this application by reference); divanillins (especially as described in WO 2004/078302, which with respect to the corresponding compounds disclosed therein forms part of this application by reference) and 4-hydroxydihydrochalcones (preferably as described in US 2008/0227867 A1, which with respect to the corresponding compounds disclosed therein forms part of this application by reference), especially phloretin and davidigenin, amino acids or mixtures of whey proteins with lecithins, hesperetin as disclosed in WO 2007/014879, which with respect to these compounds forms part of this application by reference, 4-hydroxydihydrochalcones as disclosed in WO 2007/107596, which with respect to these compounds forms part of this application by reference, or propenylphenyl glycosides (chavicol glycosides) as described in EP 1955601 A1, which with respect to these compounds forms part of this application by reference, or extracts of Rubus suavissimus, extracts of Hydrangea macrophylla as described in EP 2298084 A1, pellitorin and derived flavour compositions as described in EP 2008530 A1, umami compounds as described in WO 2008/046895 A1 and EP 1989944 A1, umami compounds as described in EP 2064959 A1 or EP 2135516 A1, vanillyl lignans, enterodiol, and N-decadienoyl amino acids and mixtures thereof.

Antioxidants

Both natural and artificial antioxidants are used in the food industry. Natural and artificial antioxidants differ primarily in that the former occur naturally in food and the latter are produced artificially. Thus, natural antioxidants, if they are to be used as food additives, are obtained for example from vegetable oils. Vitamin E—also known as tocopherol—is for example often produced from soya oil. Synthetic antioxidants such as propyl gallate, octyl gallate and dodecyl gallate are in contrast obtained by chemical synthesis. The gallates may trigger allergies in sensitive persons. Other antioxidants usable in compositions of the present invention are: sulphur dioxide, E 220 sulphites sodium sulphite, E 221 sodium hydrogen sulphite, E 222 sodium bisulphite, E 223 potassium bisulphite, E 224 calcium sulphite, E 226 calcium hydrogen sulphite, E 227 potassium hydrogen sulphite, E 228 lactic acid, E 270 ascorbic acid, E 300 sodium-L-ascorbate, E 301 calcium-L-ascorbate, E 302 ascorbic acid ester, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tertiary-butylhydroquinone (TBHQ), E 319 butylated hydroxyanisole, E 320 butylated hydroxytoluene, E 321 lecithin, E 322 citric acid, E 330 salts of citric acid (E 331 & E 332) sodium citrate, E 331 potassium citrate, E 332 calcium-disodium-EDTA, E 385 diphosphates, E 450 disodium diphosphate, E 450a trisodium diphosphate, E 450b tetrasodium diphosphate, E 450c dipotassium diphosphate, E 450d trepotassium diphosphate, E 450e dicalcium diphosphate, E 450f calcium dihydrogen diphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin-II chloride, E 512.

Emulsifiers

Emulsifiers are characterized by the important property of being soluble both in water and in fat. Emulsifiers generally consist of a fat-soluble part and a water-soluble part. They are always used when water and oil must be made into a stable, homogeneous mixture. Suitable emulsifiers that are used in the food processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8)stearate (E 430) polyoxyethylene stearate (E 431) ammonium phosphatides (E 442) sodium phosphate and potassium phosphate (E 450) sodium salts of edible fatty acids (E 470 a) mono- and diglycerides of edible fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric acid monoglycerides (E 472 e) sugar esters of edible fatty acids (E 473) sugar glycerides (E 474) polyglycerides of edible fatty acids (E 475) polyglycerol-polyricinoleate (E 476) propylene glycol esters of edible fatty acids (E 477) sodium stearoyllactylate (E 481) calcium stearoyl-2-lactylate (E 482) stearyl tartrate (E 483) sorbitan monostearate (E 491) stearic acid (E 570).

Food Colorants

Food colorants or simply colorants are food additives for colouring foodstuffs. Colorants are divided into the groups of the natural colorants and the synthetic colorants.

The nature-identical colorants are also of synthetic origin. The nature-identical colorants are synthetic copies of colouring substances occurring in nature. Suitable colorants for use in the present composition are selected from: curcumin, E 100 riboflavin, lactoflavin, vitamin B2, E 101 tartrazine, E 102 quinoline yellow, E 104 yellow-orange S, yellow-orange RGL, E 110 cochineal, carminic acid, true carmine, E 120 azorubin, carmoisin, E 122 amaranth, E 123 cochineal red A, ponceau 4 R, victoria scarlet 4 R, E 124 erythrosin, E 127 allura red AC, E 129 patent blue V, E 131 indigotin, indigo carmine, E 132 brilliant FCF, patent blue AE, amide blue AE, E 133 chlorophyll, chlorophylline, E 140 copper complex of chlorophyll, copper-chlorophyllin complex, E 141 brilliant acid green, green S, E 142 caramel sugar couleur, E 150 a sulphite lye-caramel, E 150 b ammonia caramel, E 150 c ammonium sulphite-caramel, E 150 d brilliant black FCF, brilliant black PN, black PN, E 151 vegetable charcoal, E 153 brown FK, E 154 brown HT, E 155 carotene, carotene, E 160 a annatto, bixin, norbixin, E 160 b capsanthin, capsorubin, E 160 c lycopene, E 160 d beta-apo-8′-carotenal, apocarotenal, beta-apocarotenal, E 160 e beta-apo-8′-carotene acid ethyl ester (C30), apocarotene ester, beta-carotene acid ester, E 160 f lutein, xanthophyll, E 161 b canthaxanthine, E 161 g betanin, beet red, E 162 anthocyan, E 163 calcium carbonate, E 170 titanium dioxide, E 171 iron oxides, iron hydroxides, E 172 aluminium, E 173 silver, E 174 gold, E 175 lithol-rubin BK, ruby pigment BK, E 180.

Industrial Usability

The present patent application further relates to acid whey-based compositions with and without egg yolk. The acid whey-based composition is a so-called semi-finished product.

The acid whey base is especially advantageous as it can be formulated both with egg yolk and without egg yolk. Especially for egg-free products, preferably for consumers who do not tolerate egg yolk, the acid whey base offers an excellent opportunity for obtaining products on this basis that have a high nutrition-physiological value and at the same time taste good.

The processing of egg yolk into the acid whey base is also an object of the invention. The acid whey base as semi-finished product (or products) with egg yolk not only has the high nutrition-physiological value that is provided by acid whey, but also has excellent stability and texture.

For the manufacturers, the acid whey base, with and without egg yolk, is therefore advantageous, as it is stable and as semi-finished product already offers wide coverage, so that many end products can be produced therefrom.

### EXAMPLES

Preparation of the Acid Whey-Based Composition with Subsequent Processing to the Dressing

a) Production of Skimmed Milk Yoghurt

Skimmed milk (99.90%) with a fat fraction of 0.1% is warmed (55° C.), homogenized, heat-treated (95° C., heat maintained for 3 minutes) and cooled to 40° C. Then thermophilic bacterial cultures Streptococcus thermophilus and Lactobacillus (delbrueckii subsp. bulgaricus) are added and it is fermented at approx. 40° C. As soon as a specified pH (acid value) is reached, the yoghurt is stirred until smooth, cooled to refrigerator temperature (<8° C.), filled and sealed immediately.

b) Production of the Acid Whey Base

The yoghurt produced is mixed with acid whey. Optionally pectin, WPC, buttermilk powder, sugar and egg yolk are now added to this mixture. Then it is heated to 90 to 92° C. Next the mass is homogenized at 250 bar and is then cooled.

c) Production of the Dressing

The acid whey-based composition from b) and optionally WPC are emulsified in an emulsifying machine (IKA Master Plant) at 6000 rev/min. Oil and stabilizers are added and after 60 s, oil and salt and vinegar are added. The acid whey composition with the added oil, stabilizers, salt and vinegar is emulsified for 600 s at 6000 rev/min. Then the emulsified composition is heat-treated at 75° C. for 600 s, with stirring. It is then filled and is cooled within max. 60 minutes to cold store temperature (<8° C.).

### Example 1

### Acid Whey-Based Compositions

Acid whey-based compositions were produced according to the above production a) to b). The stability and the organoleptic impression of the acid whey-based compositions produced were then assessed.

The stability was assessed visually, with particular attention to whether the consistency of the compositions produced coincides (with little deviation) with the standard.

TABLE 2
Acid whey-based compositions (amounts stated as wt %)

| Mixture | Acid whey | Yoghurt | Pectin | Sugar | Egg yolk |
|---|---|---|---|---|---|
| A | 67 | 33 | 0.42 | — | — |
| B | 67 | 33 | 0.42 | 5.43 | — |
| C | 67 | 33 | 0.8 | 5.43 | — |
| D | 67 | 33 | 1.1 | 5.43 | — |
| E | 67 | 33 | 1.1 | 5.43 | 0.84 |
| F | 67 | 33 | 1.0 | 5.43 | — |

TABLE 3
Assessment of the acid whey-based compositions

| Mixture | Stability | organoleptic assessment |
|---|---|---|
| A | stable | inadequate |
| B | less stable | inadequate |
| C | fairly stable | good |
| D | stable | good |
| E | stable | adequate |
| F | stable | good |

Mixture E was also tested in the dressing (production according to c). Good emulsification behaviour is observed. However, the dressing requires additional flavourings to improve the taste note.

Mixture F was also tested in the dressing (production according to c). The dressing also showed good emulsification behaviour and at the same time a good taste note.

### Example 2

### Emulsification Behaviour of Acid Whey-Based Compositions

Acid whey-based compositions were produced according to the above production a) to b) and the stability was assessed after particle distribution in the dressing.

TABLE 4
Acid whey-based compositions (amounts stated as wt %)

| Mixture | Acid whey | Yoghurt | Pectin | Sugar | Egg yolk |
|---|---|---|---|---|---|
| G | 50 | 50 | 1.0 | 5.43 | |
| H | 50 | 50 | 1.0 | 5.43 | 0.84 |
| I | 67 | 33 | 1.0 | 5.43 | |
| J | 67 | 33 | 1.0 | 5.43 | 0.84 |
| K | 80 | 20 | 1.0 | 5.43 | |
| L | 80 | 20 | 1.0 | 5.43 | 0.84 |
| M | 100 | — | 1.0 | 5.43 | |
| N | 100 | — | 1.0 | 5.43 | 0.84 |

The acid whey-based compositions G to N all have a good smooth structure and are stable.

Next the acid whey-based compositions G to N were processed to the dressing with the basic recipe in Table 2 (according to production c)). The stability of the dressings was determined by particle distribution measurements (HELOS laser diffraction particle analysis, Sympatec GmbH). For this, the particle distribution was determined as follows: the undiluted sample was analysed by means of the laser diffraction sensor HELOS (Sympatec GmbH).

The stability was determined from the particle distribution, wherein a particle distribution of x(50%) (median) was determined and was assessed as follows: A value:
under 10=very good,
under 20=good,
under 30=adequate,
starting from 30=inadequate (unstable)

In warm storage, higher values are observed, indicating that the structure becomes more unstable.

TABLE 5
Particle distribution of acid whey-based compositions in dressings

| | Cold storage | Warm storage |
|---|---|---|
| Dressing | x (50%) μm | x (50%) μm |
| Standard | 15.0 | 14.5 |
| (example 1) | | |
| G′ | 23.5 | 24.4 |
| H′ | 7.0 | 6.6 |
| I′ | 29.0 | 26.2 |
| J′ | 6.6 | 7.0 |
| K′ | 23.1 | 24.0 |
| L′ | 6.1 | 6.2 |
| M′ | 20.5 | 18.0 |
| N′ | 5.7 | 5.7 |

Regardless of the different acid whey/yoghurt mixture ratios, formation of emulsion is greatly improved by adding egg yolk. Even when there is no additional use of egg yolk, a stable dressing can be produced with the different acid whey/yoghurt mixture ratios. However, the particle distributions of the egg-free and egg-containing dressings differ from the standard dressing, in that the egg-containing dressings have a lower and narrower particle distribution, and the egg-free ones in contrast have a higher value, i.e. have a higher range.

The dressings had sufficient stability of up to 4 weeks.

The organoleptic assessments are in the good to acceptable range for dressings G′ to N′. With further additives, they could always be improved in taste and adjusted to the user's taste.

### Example 3

Stability of Dressings with and without Egg Yolk

The acid whey base J from example 2 was used and was processed to the dressing according to production c), wherein the egg yolk was varied and for comparison was also omitted.

TABLE 6
Acid whey-based compositions in dressings
with and without egg yolk

| | Dress- | | | |
|---|---|---|---|---|
| No. | ing | Egg yolk | Stability | Texture |
| 1 | I′ | — | adequate | smooth and homogeneous |
| 2 | J′ | egg yolk | very good | smooth and homogeneous |
| | | powder * | | |
| 3 | J′ | egg yolk | very good | smooth and homogeneous |
| | | plasma ** | | |
| 4 | J′ | egg yolk | inadequate | smooth, but phase |
| | | granules ** | | separation |

* from the company Sanovo
** from egg yolk fractionation according to FEI AiF 15512N

The stability was determined from the particle distribution, wherein a particle distribution of x (50%) μm (median) was determined and was assessed as follows:

TABLE 7
Particle distribution of acid whey-based compositions
in dressings with and without egg yolk

| Dressing | Cold storage | Warm storage |
|---|---|---|
| No. | x (50%) μm | x (50%) μm |
| 1 | 17.7 | 28.5 |
| 2 | 8.2 | 8.5 |
| 3 | 4.8 | 4.9 |
| 4 | 23.7 | 26.0 |

A value:
under 10=very good
under 20=good
under 30=adequate
starting from 30=inadequate (unstable)

In warm storage, higher values are observed, indicating that the structure is unstable.

### Example 4

Stability of Dressings with Milk Powder (Addition During Production of the Semi-Finished Products)

The acid whey bases I and M were additionally produced (O) with buttermilk powder according to the above production a) and b) and were processed to the dressing according to production c). This was compared with the buttermilk-free mixture.

TABLE 8
Particle distribution of acid whey-based composition
in dressings with buttermilk powder

| | Cold storage | Warm storage |
|---|---|---|
| Dressing | x (50%) μm | x (50%) μm |
| I′ (without buttermilk powder) | 29.0 | 26.2 |
| O′ (with buttermilk powder) | 10.9 | 11.0 |
| M′ (without buttermilk powder) | 21.1 | 21.8 |
| O′ (with buttermilk powder) | 13.5 | 9.6 |

A value:
under 10=very good
under 20=good
under 30=adequate
starting from 30=inadequate (unstable)

Addition of buttermilk powder leads to a decrease in particle distribution. This is observed both in the yoghurt/acid whey mixture and when using 100% acid whey.

1-15. (canceled)

16. An acid whey-based composition comprising
(a) 70.0 to 99.9 wt. % acid whey,
(b) 0.5 to 50.0 wt. % milk products, selected from the group consisting of yoghurt, fermented milk, crème fraîche, sour cream, cultured cream, kefir (kefir mild),
(c) 0.05 to 2.0 wt. % stabilizer,
(d) 0.5 to 9.0 wt. % sugar and/or sugar substitutes and/or sweeteners,
(e) 0.5 to 2.0 wt. % egg yolk,
wherein the sum of components (a) to (e) comes to 100 wt. %.

17. The composition of claim 16, wherein the milk product b) is yoghurt that is derived from yoghurt milk and, which is selected from skimmed, full-cream and fat content-standardized milk and the yoghurt is a compact or stirred yoghurt

18. The composition of claim 16, wherein the fat content in the yoghurt milk is from 0.1 o 40 wt. %.

19. The composition of claim 16, wherein the yoghurt from yoghurt milk is skimmed milk and the fat content is 0.1 wt. %.

20. The composition of claim 16, wherein the stabilizer is selected from cellulose derivatives, in particular CMC (E466), propylglycol alginates (E405), soybean polyose (E426) and/or pectins (E440).

21. The composition of claim 16, wherein the egg yolk is selected from the group consisting of whole egg yolk, egg yolk powder, enzyme-treated egg yolk powder, separated egg yolk fractions of plasma and/or granules fractions.

22. A dressing, a cream, a sauce, an edible emulsion or an edible foam comprising the composition of claim 16.

23. The product of claim 22, further comprising additional ingredients, selected from sweeteners, food-grade acid, thickeners, reducing agents, aromatic substances, vitamins, prebiotic substances, probiotic substances, flavour nhancers, active substances for masking unpleasant taste impressions,antioxidants, food colorants and mixtures thereof,

24. A method for producing a dressing, a cream, a sauce or an edible foam, wherein the composition of claim 16 is provided as a basis for the overall composition.

25. An emulsifier system comprising the composition of claim 16.
